(19) United States
(12) Patent Application Publication
(10) Pub. No.: US 2002/0094756 A1
(43) Pub. Date: Jul. 18, 2002

(54) Pest-trapping tray for beehive

(76) Inventor: Serge J. Labesque, Glen Ellen, CA (US)

Correspondence Address: SERGE J. LABESQUE, 2300 WARM SPRINGS ROAD, GLEN ELLEN, CA, 95442, US

(21) Appl. No.: 09/760,902

(22) Filed: Jan. 17, 2001

(51) Int. Cl. A01K 51/00

(52) U.S. Cl. 449/56

(57) ABSTRACT

A tray having a peripheral obstruction (10) surrounding a plateau (20), which can be inserted in the bottom of beehives to trap pests and parasites.

### BACKGROUND—FIELD OF INVENTION

This invention relates to beehive bottom boards, specifically to such boards that are used to collect certain types of parasitic mites and other honeybee pests.

### BACKGROUND—DISCUSSION OF PRIOR ART

Apiculturists commonly place flat boards in the bottoms of their beehives. These boards are covered with an adhesive film or coated with viscous substances. Inserted under a screen, these boards allow the apiculturists to detect the presence of parasites, such as varroa jacobsini mites, by trapping some of the parasites that fall onto them. Such boards are known as “sticky boards”. U.S. Pat. No. 4,867,731 to Willard, et al. describes such an apparatus.

However, wax flakes, cell capping, insects and other hive debris also fall onto the board. This matter, as it accumulates, can rapidly cover the adhesive surface, thus allowing the pests to escape the board and climb back up into the hive. Unless the adhesive film of the board is regularly replaced or cleaned, the board becomes ineffective at trapping pests and parasites. Performing this maintenance is quite often impractical for those apiculturists who move their hives to distant locations. This maintenance is also costly, because of the significant amount of labor that is required and because of the large quantities of adhesive materials that are necessary.

Moreover, as the ambient temperature drops, the adhesive films and the viscous coatings lose their effectiveness.

To control the mites and other pests, apiculturists occasionally medicate their hives. Whenever this is done, it is important that the bottom boards retain a maximum of efficacy at trapping the parasites that have not been killed, since these could develop into strains that are resistant to the treatment.

Furthermore, most boards are made of thin plywood or similarly porous materials that are easily penetrated by the adhesive or viscous coatings. These boards have to be discarded when the greasy substances used to coat them become rancid or when they develop strong and unpleasant odors that may penetrate the wax or the honey contained in the hives.

Therefore, it can be seen that the heretofore known beehive bottom boards suffer from a number of disadvantages:

(a) The upper surfaces of the bottom boards require frequent cleaning, as hive debris rapidly accumulates on them.

(b) Cleaning the upper surfaces of the boards and replacing the adhesive films or coatings is costly, both in labor and in materials.

(c) Their practical use is limited to the detection and monitoring of parasites in the beehives.

(d) The adhesive films and coatings become less effective when the ambient temperature drops.

(e) Their loss of efficacy at trapping pests between cleanings facilitates the development of medication-resistant strains of the parasites and pests.

(f) They have to be discarded whenever the coating material that penetrates them becomes rancid.

### Objects and Advantages

Accordingly, several objects and advantages of the present invention are:

(a) To provide a beehive bottom tray that offers a definite element of control over beehive parasites without the use of chemical substances.

(b) To provide a beehive bottom tray that does not require frequent cleaning to maintain its efficacy.

(c) To provide a beehive bottom tray that allows debris to accumulate on its surface while still retaining its effectiveness in trapping pests that have fallen onto it.

(d) To provide a beehive bottom tray, the use and maintenance costs of which are reduced.

(e) To provide a beehive bottom tray that retains effectiveness when the ambient temperature drops.

(f) To provide a beehive bottom tray that is made of impervious materials.

(g) Further objects and advantages are to provide a beehive bottom tray that is inexpensive to manufacture. Still further objects and advantages will become apparent from the ensuing description and drawing.

### DRAWING FIGURE

FIG. 1 is a perspective view of a pest-trapping tray with peripheral obstruction.

### REFERENCE NUMERALS IN DRAWINGS

10 peripheral channel

12 frontal flange

14 lateral flange

16 posterior flange

18 handle

20 plateau

22 recess

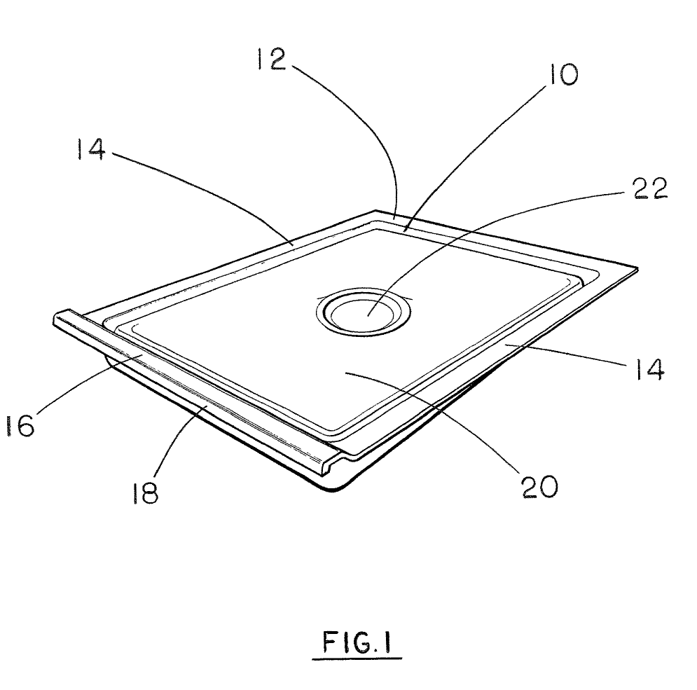

### DESCRIPTION—FIG. 1

A typical embodiment of the pest-trapping tray of the present invention is illustrated in FIG. 1 (perspective view). A peripheral channel 10 surrounds a plateau 20. A frontal flange 12, lateral flanges 14 and a posterior flange 16 surround peripheral channel 10. The rearmost edge of the tray, along posterior flange 16, is formed into a handle 18. A recess 22 is formed in the upper surface of plateau 20.

Operation—FIG. 1

Peripheral channel 10 is filled with a substance such as thin oil or other viscous material. After the bottom tray has been inserted into a beehive bottom that is designed to receive it, debris that falls from the beehive onto the tray accumulates on plateau 20. Varroa jacobsini mites and other pests that fall on the tray are trapped on plateau 20 and prevented by peripheral channel 10 from escaping.

When the tray is inserted into the bottom of the hive, the space that separates the hive floor from the pest-trapping tray is enclosed by frontal flange 12, lateral flanges 14 and posterior flange 16. Frontal flange 12 abuts the landing board of the hive. Lateral flanges 14 suspend the tray in the hive bottom and allow it to be slid in and out of the hive. Posterior flange 16 interfaces with the posterior rail of the hive bottom. Plateau 20 is located lower than flanges 12, 14 and 16 to allow hive debris to accumulate on it and to reduce the risk of spillage. Recess 22 may be used to introduce volatile substances in the hive. In the preferred embodiment of this invention, the upper surface of plateau 20 is concave and the tray is molded out of a thermoformable plastic material or produced by a resin injection process, or other resin transfer molding process.

Peripheral channel 10 is dimensioned to minimize the quantity of material that is necessary to fill it and still be an effective barrier for the pests that drop on plateau 20. As beehives should typically be leaning forward, peripheral channel 10 is deeper along posterior flange 16 than it is along frontal flange 12, and it gradually varies in depth along lateral flanges 14. This is to ensure that some of the liquid will be present all around plateau 20, thus preventing the pests from escaping from the tray, while minimizing the amount of liquid that is necessary.

From the description above, a number of advantages of this pest-trapping tray become evident:

(a) The pests that have fallen from the beehive onto the tray are trapped in spite of the accumulation of debris.

(b) A degree of control over the infestation of the beehive is achieved without use of pesticide.

(c) The tray remains effective for longer periods of time.

(d) Less frequent cleaning of the beehive bottom tray is required.

(e) The liquid material that is placed in the channel of the tray can be filtered and reused. This ensures that the amount of material necessary to maintain the efficacy of the tray and its associated cost are kept low.

(f) The peripheral channel can be filled with substances that remain liquid or viscous at reasonably low ambient temperatures, or that do not evaporate during periods of hot weather, ensuring that the tray retains its effectiveness over a wide range of temperature conditions.

(g) The beehive bottom tray, being fabricated out of impervious materials, does not leak or absorb oily substances that would become rancid.

(h) The shape of the tray is simple enough to allow for inexpensive fabrication processes such as thermoforming, resin injection or resin transfer.

(i) Since only a small volume of liquid is necessary to fill the channel, the quantities that could be spilled are insignificant. Furthermore, should the tray be tilted, the liquid would tend to flow onto the plateau, which is lower than the flanges, rather than spill out of the tray.

(j) The small quantity of material that is required to fill the peripheral channel, combined with the ease of filtering and reusing the liquid reduces the amount of material to be handled.

### Summary, Ramifications and Scope

Accordingly, it can be seen that the beehive bottom tray of this invention can be used to trap pests that fall onto it, without requiring frequent cleaning of its surface and replacement of the adhesive film or coating material to maintain its efficacy.

Furthermore, the peripheral channel is a simple feature that has the additional advantages in that

It provides an elements of control over certain bee parasites and pests without chemical medication;

it allows the production of the tray through inexpensive fabrication processes;

it allows for less frequent visits to the apiary than when traditional “sticky boards” are in use;

it reduces the quantities and costs of the adhesive coatings that are required to trap the pests;

it permits a reduction of the costs of cleaning and maintaining an effective pest trapping hive bottom;

it permits the accumulation of debris on the tray without reducing its efficacy;

Although the description above contains many specificities, these should not be construed as limiting the scope of the invention, but as merely providing illustrations of some of the presently preferred embodiments of this invention. For example, the plateau may be designed to allow the accumulated debris to fall out, thus permitting even less frequent cleaning of the tray; the pest-trapping tray may also be fabricated out of a transparent material such as polycarbonate, to permit a visual inspection of the hive bottom without retracting the tray; a grid pattern may be printed on the upper surface of the plateau to facilitate the count of parasites that have fallen on the tray.

Thus the scope of the invention should be determined by the appended claims and their legal equivalents, rather than by the examples given.

I claim:

1. In a beehive bottom tray, comprising a peripheral obstruction, means for preventing pests from escaping said tray, and a central area surrounded by said peripheral obstruction, means for allowing hive debris to accumulate.

2. The beehive bottom tray of claim 1 wherein said peripheral obstruction is a channel.

3. The beehive bottom tray of claim 1 wherein said central area has a concave upper surface.
